(19) United States
(12) Patent Application Publication
(10) Pub. No.: US 2012/0117517 A1
(43) Pub. Date: May 10, 2012

(54) USER INTERFACE

(75) Inventors: Simon FRADKIN, Blackburn (GB); David HARRISON, Blackburn (GB)

(73) Assignee: PROMETHEAN LIMITED, Lancashire (GB)

(21) Appl. No.: 13/288,511

(22) Filed: Nov. 3, 2011

(30) Foreign Application Priority Data
Nov. 5, 2010 (GB) 1018769.8

(51) Int. Cl. G06F 3/033

(52) U.S. Cl. 715/863

(57) ABSTRACT

A method of controlling a user interface comprising the steps of: detecting movement of a contact continuously between a first contact point at which contact is made and a second contact point at which contact is released; determining a state of a selection/de-selection mode of operation in dependence on: a line traced between the first contact point and the second contact point traversing one of more objects of an application layer; the first contact point not being co-incident with an object of the application layer; and the second contact point not being coincident with an object of the application layer.

### BACKGROUND TO THE INVENTION

1. Field of the Invention

The invention relates to an improved user interface, and particularly but not exclusively to a user interface presented in combination with an interactive display surface.

2. Description of the Related Art

Interactive display systems are well-known. In an interactive display system, a user (or users) interact with a display surface on which an image is projected. In one known environment, the interactive display surface may be a display surface of an electronic whiteboard, which is used in a classroom environment for educational purposes.

In such systems, the user stands at or close to the display surface, and interacts with the display surface. Different types of interactive display surface are possible, and the user may interact with the surface by using a finger in a touch-sensitive system, or by using a pointer. Where a pointer is used, the interaction between the pointer and the display surface may be by means other than touch-sensitive means.

In such systems, the use of the pointer (or finger) at the interactive display surface may be for the same purpose as a mouse in a desktop computer system. The user uses the pointer to control a cursor displayed on the display screen, and to select icons and tools displayed on the display screen. In this way the user can manipulate the information displayed in the same manner as they may manipulate information using a desktop computer, but the manipulation takes place at the display on which information is displayed to a classroom. In this way the display is an electronic whiteboard.

It is known in the art to provide pointers for use with such interactive display systems with buttons, which buttons can be used to simulate “mouse clicks”. It is also known in the art to use pressure-sensitive pointers, which can be used to simulate “mouse clicks”.

Whilst there is provided in the art pointers which are adapted to allow the functionality of a mouse to be replicated, when a user is using a desktop computer they may also use one or more keyboard keys in combination with using a mouse or mouse buttons to select certain functionality. In an interactive display system, the use of the keyboard is generally not possible, and is generally undesirable as the purpose of the interactive display is for the user to be able to stand at or close to the display surface and not use a keyboard.

Furthermore in interactive display systems which incorporate touch sensitive displays, the additional functionality provided by switches on a pen are not available.

It is an aim of the invention to provide an improved technique for a user interface.

### SUMMARY OF THE INVENTION

There is disclosed a method of controlling a user interface comprising the steps of: detecting movement of a contact continuously between a first contact point at which contact is made and a second contact point at which contact is released; determining a state of a selection/de-selection mode of operation in dependence on: a line traced between the first contact point and the second contact point traversing one of more objects of an application layer; the first contact point not being co-incident with an object of the application layer; and the second contact point not being coincident with an object of the application layer.

The state of the mode may be a selection mode if the one or more objects were unselected prior to the detecting step. The state of the mode may be a de-selection mode if the one or more objects were selected prior to the detecting step.

The state of the mode may be a selection mode if a predetermined one or more objects were unselected prior to the detecting step. The state of the mode may be a de-selection mode if a predetermined one of the one or more objects were selected prior to the detecting step.

The one or more objects traversed may be displayed in more than one application layer, being different to the application layer in which the first and second contact points are detected. The first and second contact points may be detected in the same application layer.

The mode of operation may be selection of objects for deletion. The deletion may be activated automatically.

There may be provided a computer program adapted, when run on a computer, to perform any defined method. There may be provided a computer program product for storing computer program code which, when run on a computer, performs any defined method.

The invention provides a computer system adapted for controlling a user interface comprising: means for detecting movement of a contact continuously between a first contact point at which contact is made and a second contact point at which contact is released; means for determining a state of a selection/de-selection mode of operation in dependence on: a line traced between the first contact point and the second contact point traversing one of more objects of an application layer; the first contact point not being co-incident with an object of the application layer; and the second contact point not being coincident with an object of the application layer.

The state of the mode may be a selection mode if the one or more objects were unselected prior to the detecting step. The computer system may be further adapted such that the state of the mode is a de-selection mode if the one or more objects were selected prior to the detecting step.

The computer system may be further adapted such that the state of the mode is a selection mode if a predetermined one or more objects were unselected prior to the detecting step.

The computer system may be further adapted such that the state of the mode is a de-selection mode if a predetermined one of the one or more objects were selected prior to the detecting step.

The computer system may be further adapted such that the one or more objects traversed are displayed in more than one application layer, being different to the application layer in which the first and second contact points are detected.

The computer system may be further adapted such that the first and second contact points are detected in the same application layer.

The computer system may be further adapted such that the mode of operation is selection of objects for deletion. The computer system may be further adapted such that the deletion is activated automatically.

### BRIEF DESCRIPTION OF THE FIGURES

The invention will now be described by way of example with reference to the accompanying figures in which:

FIG. 1 illustrates an exemplary interactive display system in which embodiments of the invention may be implemented;

FIG. 2 illustrates a method in accordance with an embodiment of the invention; and

FIG. 3 illustrates an exemplary computer system architecture identifying the means for implementing embodiments of the invention.

### DESCRIPTION OF THE PREFERRED EMBODIMENTS

The invention is described herein by way of reference to specific preferred embodiments and implementations. One skilled in the art will appreciate that the invention is not limited to the specifics of any arrangement described herein. In particular the invention is described herein in the context of an exemplary interactive display system, and one skilled in the art will appreciate that the invention is not limited to the specifics of the described interactive display system. The invention is in general advantageously applicable to any arrangement in which a pointing device (which may be a physical device, a user's finger) interacts with a display surface, but is not limited to such arrangements.

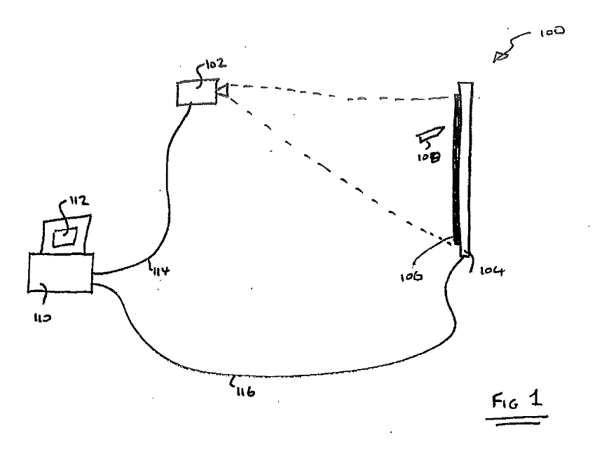

With reference to FIG. 1, there is illustrated an interactive display system 100 within which a user interface adapted in accordance with the principles of the invention may advantageously be used. The interactive display system 100 includes a projector 102, a display board 104 having a display surface 106, a pointer 108, and a computer 110 having an associated display 112. The computer 110 is connected to the projector 102 via a communication link 114, and is connected to the display device 104 by a connection 116.

The operation of interactive display systems such as that illustrated in FIG. 1 are well-known to those skilled in the art. In general, the projector 102 is controlled by the computer 110 to project onto the display surface 106 images. A user uses a pointer 108 to manipulate the images displayed on the display surface 106. For example the user may use the pointer 108 in the way that a mouse of a computer system is used, to move a cursor around the display surface, and to select objects displayed on the display surface. Although a pointer is illustrated in FIG. 1, in alternative interactive display systems a user's finger may be used to manipulate images on the display surface. In general the pointer 108 may be considered a pointing means, which term encompasses a physical device or a user's finger. The interactive display surface may be a touch-sensitive surface, or any other type of interactive surface. The display device 104 is adapted to operate in combination with the computer system 110 to determine the location of the pointer 108 on the display surface 106, and to determine any actions carried out by the pointer, such as selection of an icon. The computer 110 then updates the displayed image projected through the projector 102 in dependence upon detection of action of the pointer 108.

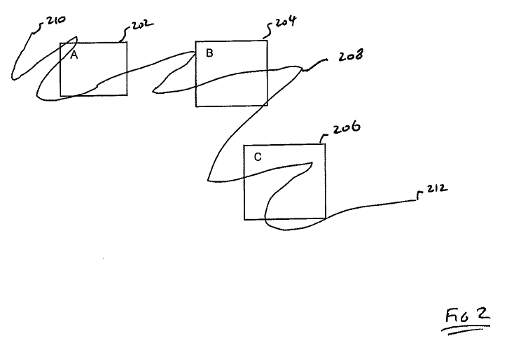

The invention is now described by way of reference to FIG. 2 and an exemplary embodiment.

Within a system of managing objects, in accordance with the invention selection of objects can be created by using a device (e.g. digital pen, mouse or other) that draws one or more paths. When the start and end points to the paths do not intersect an object, all objects intersecting the paths are then added to the selection. Any action may then be processed on the selected objects, such as deletion etc.

For example, the objects 202, 204, and 206 labelled A, B and C in FIG. 2 will be selected: by the line 208. As can be seen the line 208 has start 210 and end 212 points which do not overlay an object.

As the pen (or touch contact) is used to draw on the board, a list of points is collected to represent the paths drawn. A short time after drawing stops, the list of points are converted to a “Qt Stroker Path”. Alternatively, a touch of a finger on the board will interrupt the delay and immediately convert the points.

Using “Q”'s functionality, the “Stroker Path” is analysed and a list of objects intersected by the points on the path is returned.

In the case of using the selection for deletion, the list of objects is iterated and each object, together with any links, such as a note's connectors, is deleted.

In an embodiment the start and end points 210 and 212 may an overlay an object, but not an object belonging to the same set as any of the objects A, B or C, or not an object in the same application layers as any of the objects A, B or C.

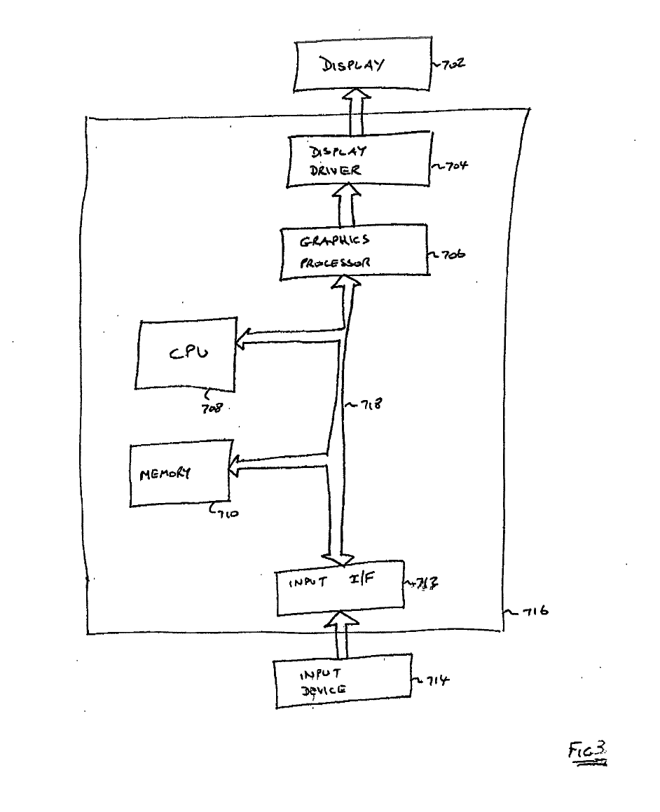

With reference to FIG. 3, there is illustrated an exemplary computer system architecture including means for implementing embodiments of the invention. The computer system is generally designated by reference numeral 716. The computer system includes a central processor unit (CPU) 708, a memory 710, a graphics processor 706, a display driver 704, and an input interface 712. The graphics processor 706, CPU 708, memory 710, and input interface 712 are interconnected via an interface bus 718. The graphics processor 706 connects to the display driver 704 via a graphics bus 720. The display driver 704 is connected to a display 702 associated with the computer system via an interface 722. The input interface 712 receives input signals on an interface 724 from an input device (or devices) 714.

The display 702 may be integrated with the computer system or be external to the computer system. The display 702 may be, for example, a display of an interactive display system. The input device 714 may be integrated with the computer system or external thereto. The input device 714 may be a pointing device associated with an interactive display surface.

In other exemplary arrangements, the display 702 may be an integrated display of a personal data system (PDA) device or other form of portable computer system. The input device 714 may be an integrated keypad of a PDA, a keyboard associated with a computer system, or a touch surface. One skilled in the art will appreciate the possible options for providing inputs to different types of computer system, and for displaying data from different types of computer system.

The methods described hereinabove may be implemented on computer software running on a computer system. The invention may therefore be embodied as computer program code being executed under the control of a processor of a computer system. The computer program code may be stored on a computer program product. A computer program product may include a computer memory, a portable disk or portable storage memory, or hard disk memory.

The invention is described herein in the context of its application to a computer system forming part of an interactive display system. It will be understood by one skilled in the art that the principles of the invention, and the embodiments described herein, are not however limited to an interactive display system. The principles of the invention and its embodiments may be implemented in any computer system including a display and a user interface. The invention and its embodiments is also not limited to the use of a pointer or touch surface type arrangement in order to move a cursor on a display. The invention encompasses any technique for the movement of a cursor, including the movement of a cursor using a conventional computer mouse.

The invention has been described herein by way of reference to particular examples and exemplary embodiments. One skilled in the art will appreciate that the invention is not limited to the details of the specific examples and exemplary embodiments set forth. Numerous other embodiments may be envisaged without departing from the scope of the invention, which is defined by the appended claims.

1. A method of controlling a user interface comprising the steps of:
detecting movement of a contact continuously between a first contact point at which contact is made and a second contact point at which contact is released;
determining a state of a selection/de-selection mode of operation in dependence on:
a line traced between the first contact point and the second contact point traversing one of more objects of an application layer;
the first contact point not being co-incident with an object of the application layer; and
the second contact point not being coincident with an object of the application layer.

2. The method of claim 1 wherein the state of the mode is a selection mode if the one or more objects were unselected prior to the detecting step.

3. The method of claim 1 wherein the state of the mode is a de-selection mode if the one or more objects were selected prior to the detecting step.

4. The method of claim 1 wherein the state of the mode is a selection mode if a predetermined one or more objects were unselected prior to the detecting step.

5. The method of claim 1 wherein the state of the mode is a de-selection mode if a predetermined one of the one or more objects were selected prior to the detecting step.

6. The method of claim 1 wherein the one or more objects traversed are displayed in more than one application layer, being different to the application layer in which the first and second contact points are detected.

7. The method of claim 1 in which the first and second contact points are detected in the same application layer.

8. The method of claim 1 wherein the mode of operation is selection of objects for deletion.

9. The method of claim 8 wherein the deletion is activated automatically.

10. A computer program adapted, when run on a computer, to perform the method of claim 1.

11. A computer program product for storing computer program code which, when run on a computer, performs the method of claim 1.

12. A computer system adapted for controlling a user interface comprising:
means for detecting movement of a contact continuously between a first contact point at which contact is made and a second contact point at which contact is released;
means for determining a state of a selection/de-selection mode of operation in dependence on:
a line traced between the first contact point and the second contact point traversing one of more objects of an application layer;
the first contact point not being co-incident with an object of the application layer; and
the second contact point not being coincident with an object of the application layer.

13. The computer system of claim 12 wherein the state of the mode is a selection mode if the one or more objects were unselected prior to the detecting step.

14. The computer system of claim 12 further adapted such that the state of the mode is a de-selection mode if the one or more objects were selected prior to the detecting step.

15. The computer system of claim 12 further adapted such that the state of the mode is a selection mode if a predetermined one or more objects were unselected prior to the detecting step.

16. The computer system of claim 12 further adapted such that the state of the mode is a de-selection mode if a predetermined one of the one or more objects were selected prior to the detecting step.

17. The computer system of claim 12 further adapted such that the one or more objects traversed are displayed in more than one application layer, being different to the application layer in which the first and second contact points are detected.

18. The computer system of claim 12 further adapted such that the first and second contact points are detected in the same application layer.

19. The computer system of claim 12 further adapted such that the mode of operation is selection of objects for deletion.

20. The computer system of claim 19 further adapted such that the deletion is activated automatically.
